(19) United States
(12) Patent Application Publication
(10) Pub. No.: US 2024/0419052 A1
(43) Pub. Date: Dec. 19, 2024

(54) FREQUENCY CONVERSION DEVICE AND FREQUENCY CONVERSION METHOD

(71) Applicant: TOHOKU UNIVERSITY, Sendai-shi, Miyagi (JP)

(72) Inventors: Yoshiaki KANAMORI, Sendai-shi (JP); Nobuaki KIKUCHI, Sendai-shi (JP); Satoshi OKAMOTO, Sendai-shi (JP); Satoshi TOMITA, Sendai-shi (JP); Seigo OHNO, Sendai-shi (JP); Toshiyuki KODAMA, Sendai-shi (JP)

(21) Appl. No.: 18/701,736

(22) PCT Filed: Sep. 5, 2022
(86) PCT No.: PCT/JP2022/033297

§ 371 Date: Apr. 16, 2024

(30) Foreign Application Priority Data
Oct. 22, 2021 (JP) 2021-173463

(51) Int. Cl. G02F 1/35

(52) U.S. Cl. CPC G02F 1/3501; G02F 1/353; G02F 2202/30; G02F 2203/13

(57) ABSTRACT

A frequency conversion device includes a modulation unit configured to receive electromagnetic waves at a first frequency output from a wave source as input waves, and output output waves as a result of modulation to a second frequency higher than the first frequency. The modulation unit includes a modulation circuit formed by a metamaterial configured to receive the input waves and generate modulated waves. The modulation circuit generates modulated output waves as a result of time modulation of the input waves in accordance with a refractive index on which time modulation is performed based on control on at least one of dielectric constant and magnetic permeability.

### CROSS-REFERENCE TO RELATED APPLICATIONS

This application is the U.S. National Stage entry of International Application No. PCT/JP2022/033297, filed on Sep. 5, 2022, which, in turn, claims priority to Japanese Patent Application No. 2021-173463, filed on Oct. 22, 2021, both of which are hereby incorporated herein by reference in their entireties for all purposes.

### TECHNICAL FIELD

The present invention relates to a frequency conversion device and a frequency conversion method for converting the frequency of input waves and outputting the resultant waves.

### BACKGROUND ART

In recent years, communication traffic of moving bodies has been sharply increasing, leading to a wide spread use of 5th Generation (5G) mobile communication systems. The 5G communication employs milli-waves in a several GHz band to enable high-speed and large capacity communications. Still, due to the fact that the performance and penetration rate of communication devices increase every year, the communication traffic is expected to overwhelm the capacity of the 5G communication in the future. In view of this, the next generation 6G communication enabling communications with even higher speed and larger capacity than the 5G communication has been under study.

The 6G communication is expected to employ terahertz (THz) waves in an electromagnetic wave range in a THz band, which is of a higher frequency. Light sources outputting THz light have been under study for putting the terahertz waves into practice. The current THz light sources include those using a quantum cascade laser, a single-travel carrier photodiode (UTC-PD), a resonant tunnel diode, a photoconductive antenna, and the like. Unfortunately, with these current light sources, the oscillation frequency of the output light is fixed, or the modulation width is narrow. Even worse, the current light s require a large installation area due to the use of a large-scale device with poor portability and also require a cooling facility due to a large heat generation amount, leading to a large operation cost. Thus, the current light sources are mainly used for measurement devices.

To achieve a THz light source usable for the next generation communications, preferably, a device operates under normal temperature, can modulate the frequency through adjustment of the wavelength of the output waves, and is configured to have a small size. The present inventors have proposed a THz light source using an artificially made metamaterial (see, for example, PTL 1 and NPL 1). The metamaterial is an artificial optical material made of an ultrafine structure artificially made so that physical properties that do not exist in nature such as negative refractive index can be achieved.

### CITATION LIST

### Patent Literature

PTL 1: WO2019/039551

### Non Patent Literature

NPL 1: “Actively tunable THz filter based on an electromagnetically induced transparency analog hybridized with a MEMS metamaterial” Ying Huang, Kenta Nakamura, Yuma Takida, Hiroaki Minamide, Kazuhiro Hane & Yoshiaki Kanamori Scientific Reports volume 10, Article number: 20807 (2020), 30 Nov. 2020.

### SUMMARY OF INVENTION

### Technical Problem

While improvement is required for the problem described above to achieve a THz light source usable for the next generation communication, actually, metamaterials have many unknown aspects. A specific method for converting the frequency of electromagnetic waves has not yet proposed with the techniques described in PTL 1 and NPL 1. The present inventors have vigorously studied a wave source that employs a metamaterial to be capable of outputting output waves in a THz band.

An object of the invention is to provide a frequency conversion device that is configured to have a small size, that operates under normal temperature, and that can modulate the frequency of the output waves as desired, and to provide a frequency conversion method.

### Solution to Problem

An aspect of the present disclosure includes a frequency conversion device comprising a modulator configured to receive electromagnetic waves at a first frequency output from a wave source as input waves, and output output waves as a result of modulation to a second frequency higher than the first frequency, wherein the modulator includes a modulation circuit formed by a metamaterial configured to receive the input waves and generate modulated waves, and the modulation circuit includes: a first modulation circuit configured to generate first modulated output waves as a result of first modulation on a phase of the input waves through time modulation on the dielectric constant based on control of an electric field generated in the modulation circuit; and a second modulation circuit configured to generate second modulated output waves as a result of second modulation on the phase of the input waves through time modulation on the magnetic permeability based on control of a magnetic field generated in the modulation circuit, and generates modulated output waves as a result of time modulation of the input waves based on the first modulated output waves, the second modulated output waves and a refractive index on which time modulation is performed based on control on at least one of dielectric constant and magnetic permeability.

### Advantageous Effects of Invention

A device according to the invention is configured to have a small size, operates under normal temperature, and can modulate the frequency of the output waves as desired.

### BRIEF DESCRIPTION OF DRAWINGS

FIG. 1 is a block diagram illustrating a configuration of a frequency conversion device according to an embodiment of the invention.

FIG. 2 is an example of a perspective view illustrating a configuration of a modulation unit of the frequency conversion device.

FIG. 3 is an example of a perspective view illustrating a configuration of a first modulation circuit.

FIG. 4 is an example of a cross-sectional view illustrating a configuration of a first pattern formed on the first modulation circuit.

FIG. 5 is an example of a diagram illustrating a relationship between the size of the first pattern and a resonance frequency.

FIG. 6 is an example of a diagram illustrating optical properties when the first pattern is in an ON state.

FIG. 7 is an example of a diagram illustrating optical properties when the first pattern is in an OFF state.

FIG. 8 is an example of a diagram illustrating a relationship between the size of the first pattern and optical properties.

FIG. 9 is an example of a diagram illustrating a configuration of a second modulation circuit.

FIG. 10 is an example of a perspective view illustrating a configuration of a second metamaterial.

FIG. 11 is an example of a diagram illustrating physical properties of the second metamaterial.

FIG. 12 is an example of a diagram schematically illustrating modulation in the second metamaterial.

FIG. 13 is an example of a diagram schematically illustrating a magnetic field applied to the second metamaterial.

FIG. 14 is an example of a diagram schematically illustrating modulation in a modulation circuit.

FIG. 15 is an example of a diagram illustrating a state in which modulated output waves output from the modulation circuit are resonated in a resonation unit.

FIG. 16 is an example of a diagram illustrating frequency characteristics of the output waves.

FIG. 17 is an example of a diagram illustrating the performance of the frequency conversion device.

FIG. 18 is a diagram illustrating a modification of the resonation unit.

FIG. 19 is an example of a diagram illustrating a positional relationship between a wave source and the resonation unit.

FIG. 20 is an example of a flowchart illustrating a flow of processing of a frequency conversion method.

FIG. 21 is an example of a diagram illustrating a method of manufacturing the first modulation circuit.

FIG. 22 is a diagram illustrating a ferromagnetic resonance spectrum observed in a magnetic body, with the magnitude of control current input changed.

FIG. 23 is a diagram illustrating the relationship between a resonant magnetic field obtained from the ferromagnetic resonance spectrum illustrated in FIG. 22 and the control current input.

FIG. 24 is a diagram illustrating a change in a shift amount of the resonant magnetic field with respect to each input frequency of microwaves input to the magnetic body.

FIG. 25 is a diagram illustrating a change in a value of a damping constant with respect to the magnitude of the control current applied to the magnetic body.

### DESCRIPTION OF EMBODIMENTS

A frequency conversion device and a frequency conversion method according to the invention will be described below. The frequency conversion device is a device that receives and modulates electromagnetic waves in the milli-wave band, and outputs electromagnetic waves in a THz band, for example.

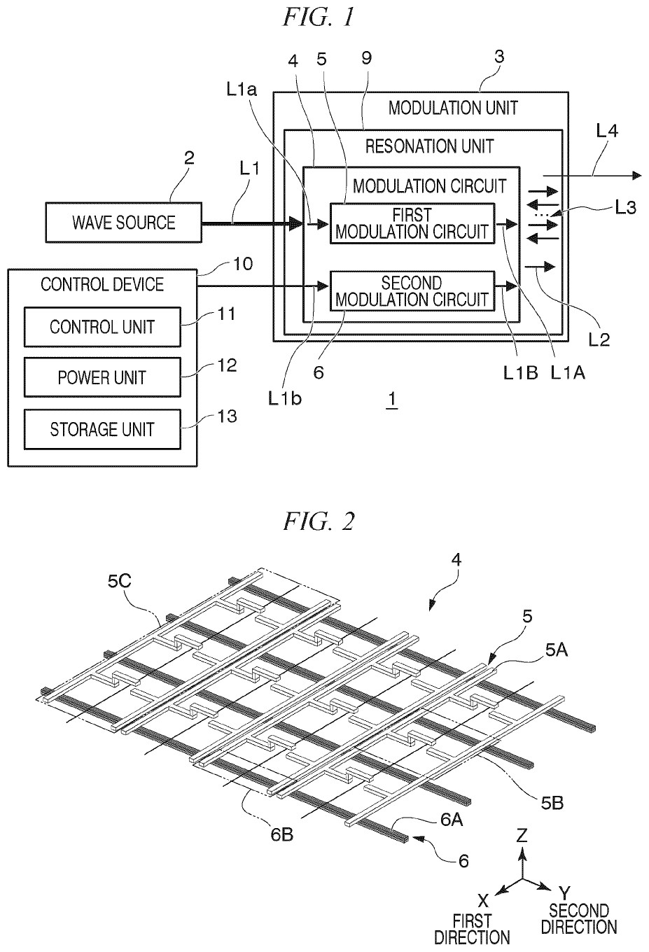

As illustrated in FIG. 1, a frequency conversion device 1 includes, for example, a wave source 2 (also referred to as a light source) that generates and outputs electromagnetic waves, a modulation unit 3 that receives the electromagnetic waves output from the wave source 2 as input waves L1 and outputs modulated output waves L2 obtained by modulating the input waves L1, and a control device 10 that controls the wave source 2 and the modulation unit 3.

The control device 10 controls the modulation by the modulation unit 3, by controlling the voltage, current, and the like to be input to the modulation unit 3, based on the timing of the output of the electromagnetic waves from the wave source 2. Based on the control, the control device 10 controls at least one of the dielectric constant and the magnetic permeability of the modulation unit 3 to control the refractive index and control time modulation of output waves L4 to be output.

For example, the control device 10 includes a power source unit 12 that generates power source voltage based on any voltage and frequency. One or more power source units 12 may be provided. The power source unit 12 is configured to generate a voltage corresponding to the modulation unit 3 and the wave source 2. The power source unit 12 may generate a driving electromagnetic field.

The power source unit 12 is controlled by a control unit 11 that causes the modulation unit 3 to execute desired modulation control. Based on a control program stored in a storage unit 13, the control unit 11 controls the power source unit 12, makes the wave source 2 generate the input waves L1, and makes the modulation unit 3 modulate the input waves L1. The control unit 11 and the storage unit 13 are, for example, configured by an information processing terminal, such as a personal computer, capable of performing calculation.

The wave source 2 generates electromagnetic waves at a first frequency (Q), for example. The electromagnetic waves are laser light in the milli-wave band, for example. The wave source 2 may generate electromagnetic waves in a frequency band other than that of the laser light. The first frequency is adjusted to be any frequency in a range from a MHz band to a GHz band, for example. The wave source 2 may output electromagnetic waves with a wavelength shorter than that of the laser light. The electromagnetic waves output from the wave source 2 are input to the modulation unit 3.

The modulation unit 3 receives the input waves L1, which are the electromagnetic waves at the first frequency output from the wave source 2, and outputs the output waves L4 as a result of modulating the first frequency. The output waves L4 are output as electromagnetic waves in the terahertz (THz) band, for example. The modulation unit 3 outputs the output waves L4 at a second frequency higher than the first frequency.

For example, the modulation unit 3 includes a modulation circuit 4 formed by an artificially made metamaterial, and a resonation unit 9 that resonates the modulated output waves L2 output from the modulation circuit 4 to generate resonant waves L3. The metamaterial is configured by an ultrafine structure artificially made so that physical properties that do not exist in nature can be achieved.

The modulation circuit 4 receives the electromagnetic waves at the first frequency output from the wave source 2 as the input waves L1, and generates the modulated output waves L2 obtained by modulating the first frequency. The modulation circuit 4 performs time modulation on the property of the electromagnetic field generated therein, to perform the time modulation on the refractive index, and thus generates the modulated output waves L2 as a result of the time modulation on the first frequency of the input waves L1.

The modulation circuit 4 generates the electromagnetic field based on the input voltage output from the control device 10, to change the refractive index thereof, for example. The modulation circuit 4 may generate the electromagnetic field by being driven not only based on the input voltage, but also by electromagnetic induction based on a temporal change in an electromagnetic field input externally.

For example, the modulation circuit 4 generates Rayleigh scattered light, Stokes scattered light shifted toward the low frequency side, and anti-Stokes scattered light shifted toward the high frequency side, through Raman scattering of the input waves L1, based on the changed refractive index.

For example, based on the changed refractive index, the modulation circuit 4 adjusts the phase of the input waves L1 received, to generate scattered light (anti-Stokes light) at a harmonic modulation frequency (Ω+ω, Ω+2ω) through addition of about 100% and 200% of a shift frequency (ω) to the first frequency (Ω), and outputs the modulated output waves L2 based on the generated scattered light.

At the same time, the modulation circuit 4 generates scattered light (Stokes light) at a sub-harmonic modulation frequency (Ω−ω, Ω−2ω) through subtraction of about 100% and 200% of the shift frequency (ω). The modulation circuit 4 according to the present embodiment uses the anti-Stokes light, of the scattered light, modulated toward the high frequency side, to output the modulated output waves L2 at the modulation frequency (Ω+ω, Ω+2ω) higher than the first frequency (Ω). The modulation circuit 4 can also output waves with the modulation frequency further finely adjusted.

The modulation circuit 4 includes, for example, a first modulation circuit 5 that performs time modulation on the dielectric constant, and a second modulation circuit 6 that performs time modulation on the magnetic permeability. For example, the first modulation circuit 5 receives and then modulates first input waves L1a to generate first modulated output waves L1A. For example, the second modulation circuit 6 receives and then modulates second input waves L1b to generate second modulated output waves L1B.

For example, the first modulation circuit 5 outputs the first modulated output waves LIA as a result of shifting the frequency of the first input waves L1a in the 0.1 to 10 MHz band. For example, the second modulation circuit 6 outputs the second modulated output waves LIB as a result of shifting the frequency of the second input waves L1b in the 0.1 to 10 GHz band. The modulation circuit 4 can perform fine frequency adjustment by causing the second modulation circuit 6 and the first modulation circuit 5 to perform upward and downward modulation of the respective input waves L1 in the GHz band and the MHz band, respectively.

The first modulation circuit 5 is driven based on the first input voltage at the first frequency generated by the power source unit 12. The first modulation circuit 5 may be driven not only based on the first input voltage, but also by the electromagnetic induction based on a temporal change in the electromagnetic field input externally.

The first modulation circuit 5 driven under control performs the time modulation on the dielectric constant thereof, to perform first modulation on the phase of the first input waves L1a based on the input waves L1, and outputs the resultant first modulated output waves LIA at a frequency higher than that of the first input waves L1a. The first input waves L1a are the second modulated output waves L1B output from the second modulation circuit 6 described below. The first input waves L1a are the input waves L1 if the second modulated output waves LIB are not output.

The first modulation circuit 5 driven performs the time modulation on the dielectric constant, to output the second modulated output waves as a result of the first modulation on the phase of the first input waves L1a. As described below, the first modulation circuit 5 finely adjusts the frequency of the second modulated output waves L1B, to generate the first modulated output waves L1A.

For example, the second modulation circuit 6 causes ferromagnetic resonance based on control, and performs second modulation on the first frequency based on anti-Stokes light of scattered waves generated through Raman scattering of the input waves, to obtain the second modulation frequency higher than the first frequency by about 10 GHz.

The second modulation circuit 6 is driven based on control of the second input voltage at the second frequency generated by the power source unit 12. The second modulation circuit 6 may be driven not only based on the second input voltage, but also by the electromagnetic induction based on control for a temporal change in the electromagnetic field input externally.

As illustrated in FIG. 2, the modulation circuit 4 is formed with the second modulation circuit 6 and the first modulation circuit 5 overlapping. The first modulation circuit 5 is formed by a first metamaterial 5A with predetermined first patterns 5B repeatedly formed. For example, based on the input of the first input voltage, the first metamaterial 5A is configured to generate an electric field and change the dielectric constant.

The first metamaterial 5A is formed with a large number of first patterns 5B arranged in a matrix. The first metamaterial 5A has the plurality of first patterns 5B arranged in series in a first direction (X-axis direction in the figure). The plurality of first patterns 5B arranged in series in the first direction form a first pattern group 5C in a row shape. A plurality of the first pattern groups 5C are arranged side by side along a second direction (Y-axis direction in the figure) orthogonal to the first direction.

The second modulation circuit 6 is formed by a second metamaterial 6A with predetermined second patterns 6B repeatedly formed. For example, based on the input of the second input voltage, the second metamaterial 6A is configured to generate a magnetic field and change the magnetic permeability.

The second metamaterial 6A includes a plurality of the second patterns 6B arranged in a row shape. The second patterns 6B are each arranged along the second direction. Each second pattern 6B is arranged at a connection portion of the first patterns 5B adjacent to each other in the first direction, as viewed along the second direction.

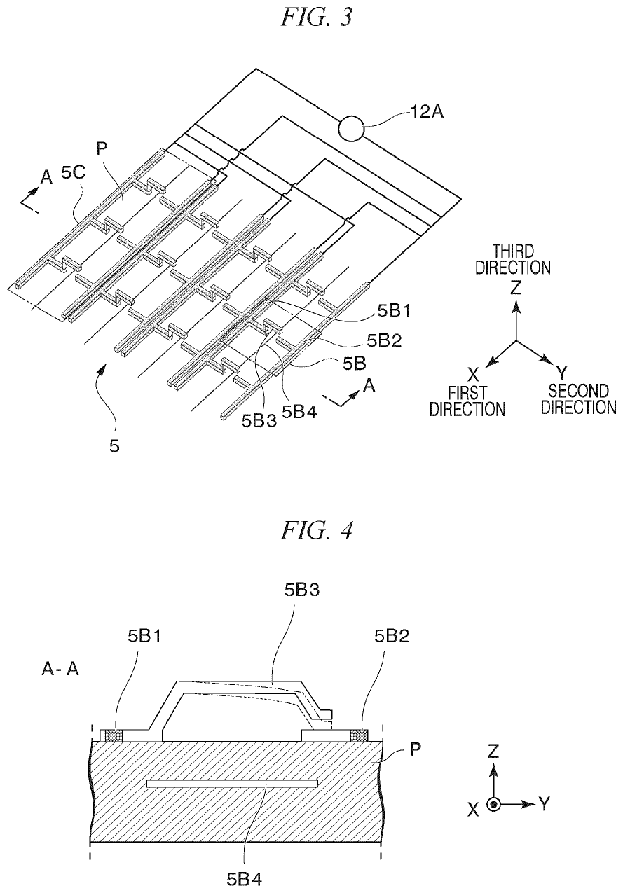

As illustrated in FIG. 3 and FIG. 4, the first modulation circuit 5 is electrically driven by a first power source 12A provided to the power source unit 12. For example, the first power source 12A outputs first voltage changing at a predetermined frequency. For example, the first pattern groups 5C are each connected in parallel to the first power source 12A. In each first pattern group 5C, the first patterns 5B are electrically connected to be capable of transmitting electrons to each other. For example, the first modulation circuit 5 generates an electric field based on the first voltage input.

The first pattern 5B is, for example, an electrode pattern formed in an H shape on a plate-shaped substrate P. For example, the first pattern 5B is formed by a metal layer in which a gold (Au) layer is overlayed on a titanium (Ti) layer. For example, the first pattern 5B is micro-electromechanical systems (MEMS) in which an electrical circuit and a fine mechanical structure are integrated on the substrate P.

The first pattern 5B is provided with, for example, a pair of a first electrode unit 5B1 and a second electrode unit 5B2 that receive the first input voltage. Thus, there is a potential difference between the pair of the first electrode unit 5B1 and the second electrode unit 5B2. A switching unit 5B3 is provided between the pair of the first electrode unit 5B1 and the second electrode unit 5B2. A third electrode 5B4 is provided on the negative side along Z direction from the switching unit 5B3.

The first electrode unit 5B1 and the second electrode unit 5B2 are, for example, formed in a bar shape along the first direction. The switching unit 5B3 is formed in a cantilever shape along the second direction, for example. The switching unit 5B3 has one end side electrically connected to the first electrode unit 5B1 side, for example. The switching unit 5B3 has the other end side separated in the +Z direction from, that is, not in electrical connection with the second electrode unit 5B2, for example. The switching unit 5B3 is formed in a trapezoidal shape raised in the +Z direction as viewed along the first direction.

The switching unit 5B3 has the other end side bent in the −Z direction and disposed in the vicinity of the second electrode unit 5B2. The switching unit 5B3 has the other end side drawn toward the third electrode 5B4, based on static electricity generated based on the first input voltage. The switching unit 5B3 is entirely flexed along the Y direction to elastically deform based on the control, and has the other end side in contact with the second electrode unit 5B2. Thus, the first electrode unit 5B1 and the second electrode unit 5B2 are electrically connected to each other.

Thus, the switching unit 5B3 switches the electrical connection between the first electrode unit 5B1 and the second electrode unit 5B2 to the ON state or the OFF state based on the first input voltage.

The first pattern 5B generates an electric field therearound based on the electrical connection by the switching unit 5B3. The switching unit 5B3 has the length in the Y-axis direction adjusted to have a first natural frequency resonating with a predetermined frequency. The length of the switching unit 5B3 in the Y-axis direction is 5 to 30 μm, for example. The switching unit 5B3 has the first natural frequency in a kHz to MHz band. A frequency f of the switching unit 5B3 is calculated based on the following Formula (1) for example.

$$\begin{matrix}[ Formula 1 ] & \\ f = \frac{0.56 d}{{L}^{2}} \sqrt{\frac{E}{12 ρ}} & ( 1 )\end{matrix}$$

Note that d denotes the thickness of a vibrator, L denotes the length of the vibrator, E denotes Young's modulus (Au), and ρ denotes the density (Au). Young's modulus (E) and the density (ρ) of gold (Au) are respectively 78 GPa and 19.32 g/cm³, for example. Of the parameters described above, the coefficients including d and L are shape values depending on the shape, and the item including E and p is a physical property value depending on physical properties.

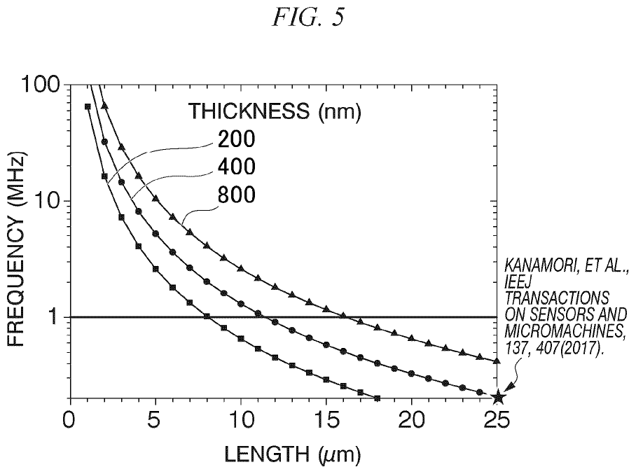

As illustrated in FIG. 5, the relationship between the length of the switching unit 5B3 and the frequency changes based on the shape values. The shape values of the switching unit 5B3 are adjusted based on desired properties. The cantilever shape is merely an example, and the switching unit 5B3 may be formed to have other shapes such as that having the other end side bent toward the second electrode unit 5B2 side. The switching unit 5B3 may be replaced with any another component that switches electrical connection between the first electrode unit 5B1 and the second electrode unit 5B2.

The switching unit 5B3 may not only be driven based on the first input voltage, but also be driven based on control on surface acoustic waves input to the substrate P or control on resonance of ultrasonic waves externally input. The switching unit 5B3 may not only be driven by using the mechanism of the cantilever, but also be driven based on an electric circuit including a transistor formed on the substrate P. The switching unit 5B3 vibrates, for example, based on the frequency of the first input voltage.

The first pattern 5B changes the peripheral dielectric constant based on a variation of the electric field generated in accordance with the connection state by the switching unit 5B3.

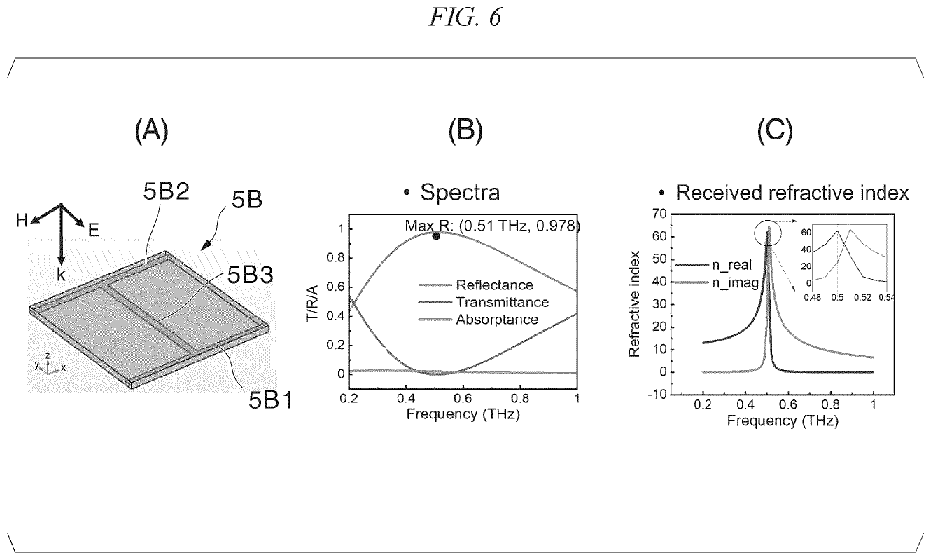

As illustrated in FIG. 6, in the ON state (see FIG. 6(A)) where the switching unit 5B3 is electrically connected, the properties of the first pattern 5B with respect to electromagnetic waves change based on a change in the dielectric constant. For example, in the state where the switching unit 5B3 is electrically connected, reflectance (R) and transmittance (T) of the first pattern 5B with respect to the electromagnetic waves change, in such a manner that electromagnetic waves at a predetermined frequency are shielded (see FIG. 6(B) and FIG. 6(C)). In the example illustrated in FIG. 6, the first pattern 5B reflects or shields electromagnetic waves at a frequency in the 0.51 THz band, in the state where the switching unit 5B3 is electrically connected.

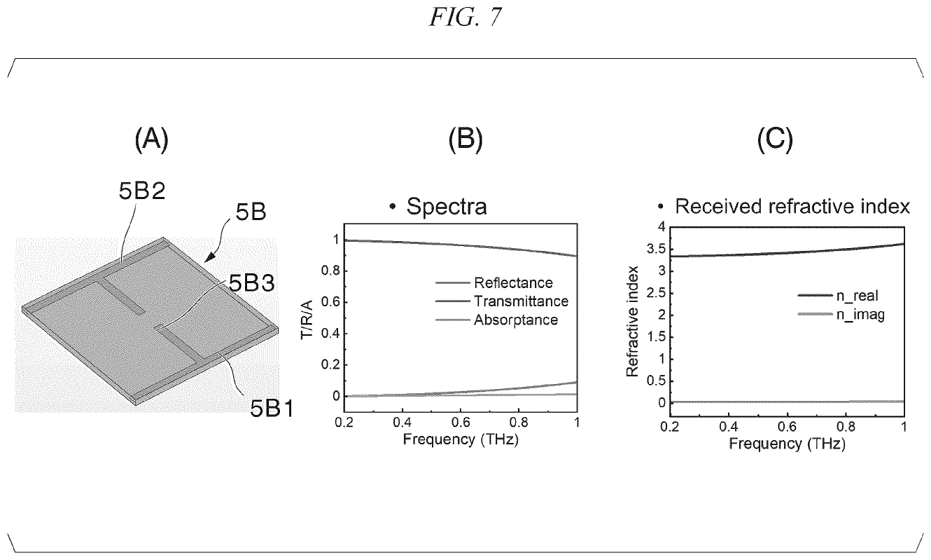

As illustrated in FIG. 7, in the OFF state (see FIG. 7 (A)) where the switching unit 5B3 is electrically disconnected, the dielectric constant of the first pattern 5B does not change, and the properties of the first pattern 5B with respect to electromagnetic waves do not change.

Thus, the first pattern 5B can switch the electrical connection between first electrode unit 5B1 and the second electrode unit 5B2 to the ON state or the OFF state based on the operation of the switching unit 5B3, and can perform time modulation on the dielectric constant generated based on a variation of the electric field generated in accordance with the connection state by the switching unit 5B3. Thus, the first pattern 5B can delay the phase of the transmitting electromagnetic waves and change the refractive index, based on the change in the dielectric constant. Based on the above principle, the first modulation circuit 5 can perform time modulation on the dielectric constant based on the control, and perform time modulation on the electromagnetic waves in a predetermined band.

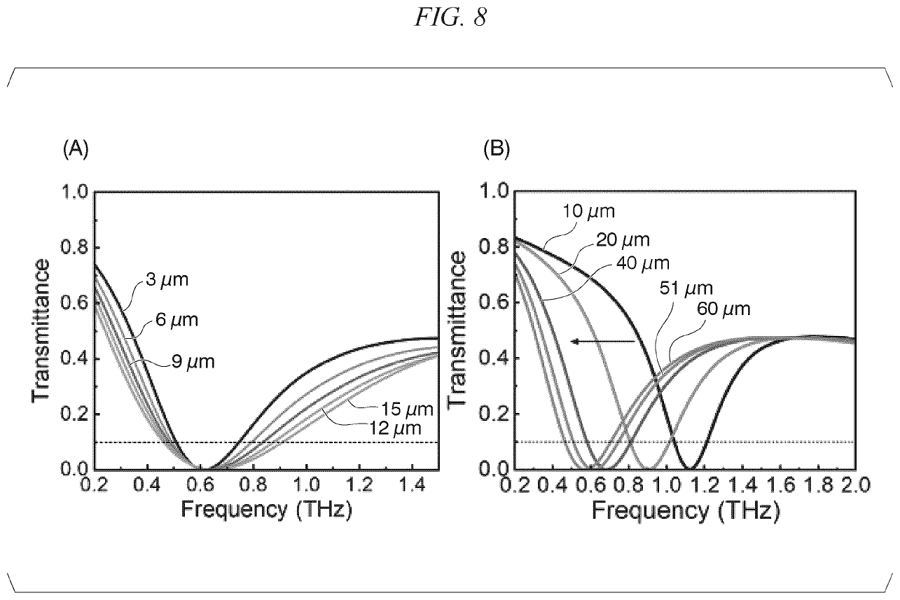

As illustrated in FIG. 8, the width (W) of the first electrode unit 5B1 and the second electrode unit 5B2 does not affect the frequency of the electromagnetic waves shielded (see FIG. 8 (A)), whereas the length (L) of the switching unit 5B3 in the Y-axis direction affects the frequency of the electromagnetic waves shielded.

Thus, the first modulation circuit 5 may include a plurality of first patterns 5B formed based on the band of the electromagnetic waves to be modulated. The plurality of first patterns 5B may be formed to overlap in the Z-axis direction, or may be formed side by side on the XY plane. The first power source 12A may adjust the first voltage and the first frequency based on the first modulation circuit 5 provided in accordance with different bands, and the control device 10 may control the first voltage and the first frequency based on the band and the modulation level of the electromagnetic waves input. The effect of the modulation of the electromagnetic waves can be improved by further combining the first modulation circuit 5 with the second modulation circuit 6.

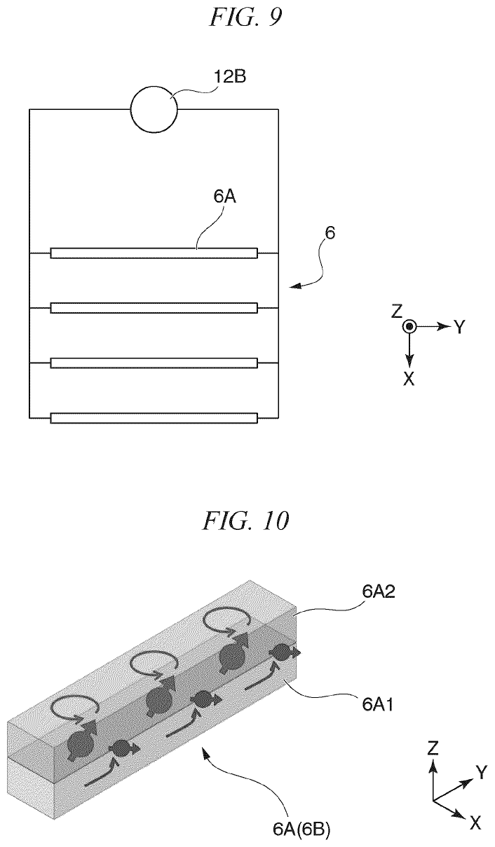

As illustrated in FIG. 9, the second modulation circuit 6 is, for example, electrically driven by a second power source 12B provided to the power source unit 12. For example, the second power source 12B outputs a control current corresponding to the second voltage changing at a predetermined frequency. For example, the control device 10 controls the value of the control current of the second power source 12B. The plurality of second metamaterials 6A provided to the second modulation circuit 6 are each connected in parallel to the second power source 12B, for example.

As illustrated in FIG. 10, the second metamaterial 6A (second pattern 6B) is formed by a first layer 6A1 on the lower layer side and a second layer 6A2 on the upper layer side that is overlaid on the first layer in the Z-axis direction. The first layer 6A1 is formed by a heavy metal such as platinum (Pt), for example. The second layer 6A2 is formed by a stacked ferromagnetic (Co/Ir) multilayered film, for example. The second layer 6A2 is formed as an ultra-high frequency magnetic body for performing time modulation on the magnetic permeability in a GHz band.

The second metamaterial 6A is formed to cause two effects. The first effect is a phenomenon known as “spin hole effect”. The spin hole effect is a phenomenon in which up/down spin polarization (spin flow) occurs due to the interaction between the spin and orbit of a material in a direction orthogonal to the current flowing in the heavy metal.

The second effect is a phenomenon known as “ferromagnetic resonance”. The ferromagnetic resonance is a phenomenon in which a huge change (Au) in the magnetic permeability occurs due to magnetic resonance induced by precession of the ferromagnetic body in response to an external input of electromagnetic waves at a frequency matching the natural frequency of the ferromagnetic body. The second metamaterial 6A is formed to be capable of performing time modulation on the magnetic permeability, through generation of a high-frequency spin flow using the spin hole effect at a high frequency, and spin injection into the ferromagnetic body in the magnetic resonance state.

The first layer 6A1 is formed to cause the spin hole effect depending on the frequency of the control current input. The ultra-high frequency magnetic body of the second layer 6A2 is formed to cause the magnetic resonance in accordance with the spin hole effect caused in the first layer 6A1, for example.

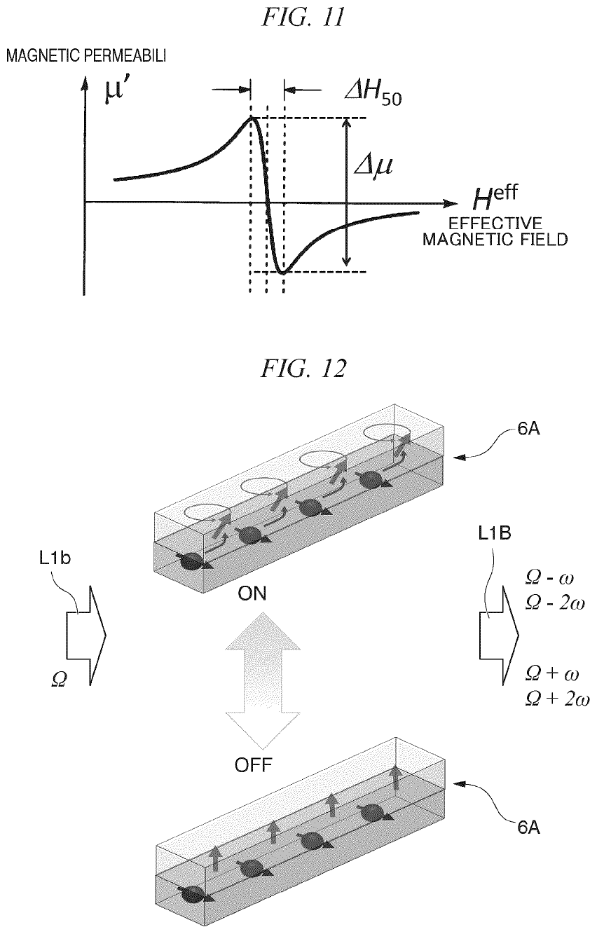

As illustrated in FIG. 11, with the ferromagnetic resonance, the magnetic permeability is largely modulated from positive to negative within a narrow frequency range. The second layer 6A2 increases the magnetic permeability based on the magnetic resonance generated by the input of the control current to the first layer 6A1, for example.

As illustrated in FIG. 12, after the second input waves Lib are input, the second metamaterial 6A increases the magnetic permeability based on the magnetic resonance, and generates the time modulated second modulated output waves L1B. For example, the second input waves L1b are millimeter waves with a first frequency (Ω) in the 10 GHZ band, with which the second modulated output waves L1B at the harmonic modulation frequency (Ω+ω, Ω+2ω) obtained through addition of about 100% and 200% of the shift frequency (ω) in the 10 GHz band to the frequency (Ω) are output.

With the configuration described above, after the input of the second input waves L1b, the second modulation circuit 6 can increase the magnetic permeability based on the magnetic resonance, and generate the time modulated second modulated output waves L1B. Here, the second input waves L1b are the input waves L1 input from the wave source 2, for example. Thus, the second modulation circuit 6 is formed by the second metamaterial 6A having the predetermined second pattern 6B for performing the time modulation on the magnetic permeability by generating the magnetic field based on the control signal. The second pattern changes the magnetic permeability based on at least one of the current, voltage, and magnetic field input, and performs the time modulation on the magnetic permeability based on the control to perform the time modulation on the current or the voltage. For example, the control signal is a voltage or current input to the second modulation circuit 6, an externally input electromagnetic field, or the like. Other control methods may be used as long as the magnetic field generated by the second metamaterial 6A can be controlled.

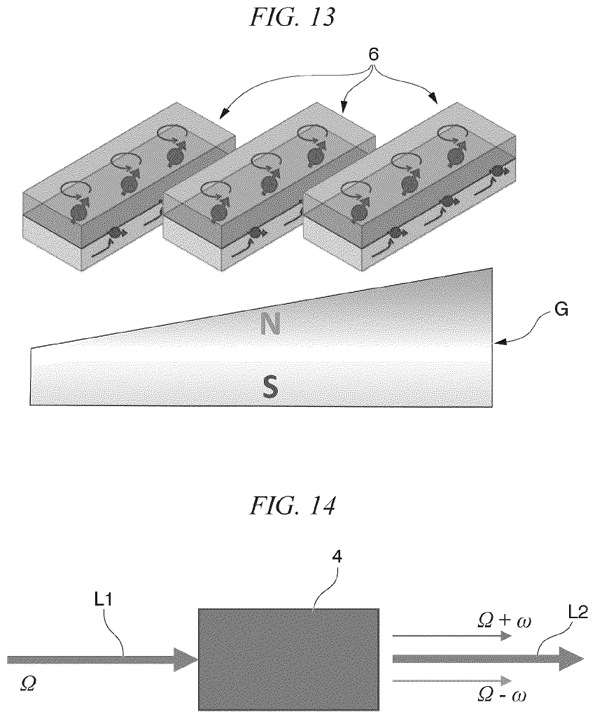

As illustrated in FIG. 13, the second modulation circuit 6 can perform the time modulation on the magnetic permeability corresponding to a wide frequency band, by being arranged in a gradient magnetic field G generated by a permanent magnet. Thus, the second modulation circuit 6 may include a plurality of the second metamaterials 6A provided to correspond to different magnetic fields. The second modulation circuit 6 modulates the input waves L1 in a modulation width of about 10 GHZ. Thus, in order to adjust the output waves to a desired frequency, the modulated output waves L2 may be generated through modulation by the first modulation circuit 5 finely adjusting the second modulated output waves LIB output from the second modulation circuit 6, to which the input waves L1 are input, in the 1 MHz band.

The modulated output waves L2 output from the modulation circuit 4 are resonated at least once by the resonation unit 9. The modulation is repeated in the modulation circuit 4, whereby the resonant waves L3 are generated. Then, the output waves L4 are output (see FIG. 1).

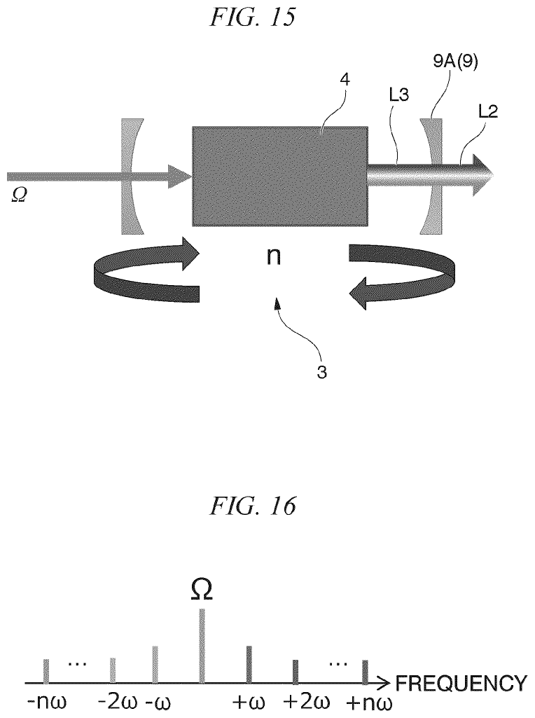

As illustrated in FIG. 15, the resonation unit 9, for example, includes cavities 9A that reflect the modulated output waves L2 output from the modulation circuit 4 at least once and output the output waves L4. The cavities 9A are, for example, concave Fabry-Perot cavities formed by a pair of semitransparent concave mirrors. The cavities 9A are formed in such a manner that reflected waves reciprocate and are modulated by the modulation circuit 4, whereby the output waves L4 are output. The interval between the cavities 9A is adjusted in such a manner that the resonance frequency thereof matches the modulation frequency of the modulation circuit 4. The resonance frequency of the cavities 9A is calculated as a reciprocal of a time required for the reciprocation of the reflected waves. The interval between the cavities 9A is about 15 mm, for example, when the shift frequency (ω) of the modulation circuit 4 is 10 GHz. The cavities 9A reflect the modulated output waves L2 therein and output the output waves L4.

The cavities 9A are, for example, formed by a metal foil film, wire grid, metal mesh, or dielectric multilayer film having a thickness of 100 nm or less, using a material such as gold, copper, and tungsten. For part of the cavities 9A, a total reflection mirror may be used.

The modulation circuit 4 receives the input waves L1 at a predetermined first frequency (Ω) and outputs the modulated output waves L2 at a modulation frequency (Ω+ω) as a result of shifting toward the high frequency side or a modulation frequency (Ω−ω) as a result of shifting toward the low frequency side. In the cavities 9A, for example, the modulated output waves L2 are reflected n times. The reflected waves are again input to the modulation circuit 4. Then, the resonant waves L3 as a result of further modulating the modulated output waves L2 are output.

As illustrated in FIG. 16, the output waves L4 with a frequency spectrum (frequency comb) obtained through addition or subtraction of the shift frequency (ω) to or from the first frequency (Ω) at an equal interval are output from the cavities 9A. The following Formula (2) expresses the phase modulation of the modulated output waves L2 modulated in the modulation circuit 4.

$$\begin{matrix}[ Formula 2 ] & \\ exp ( i Ω t + i ϕ ( t ) ) & ( 2 )\end{matrix}$$

$$ϕ ( t ) = a sin ( ω t )$$

The phase modulation of the modulated output waves L2 can be expressed by a Fourier component as a result of shifting by the shift frequency as in the following Formula (3). The amplitude of the component as a result of the nth-order shifting is expressed by an n-th order Bessel function.

$$\begin{matrix}[ Formula 3 ] & \\ exp ( i Ω t + i a sin ω t ) = exp ( i Ω t ) {\sum }_{n}^{\pm ∞} {J}_{n} ( a ) exp in ω t & ( 3 )\end{matrix}$$

$$Jn ( x ) : n - th order Bessel function$$

Here, assuming that a represents the degree of the modulation in the modulation circuit 4, φ(t) of the resonant waves L3 modulated q times by the cavities 9A is equivalent to that obtained by q modulation circuits 4 continuous in series. With the magnitude of the modulation thus increased, the following Formula (4) represents the phase modulation for single passage.

$$\begin{matrix}[ Formula 4 ] & \\ ϕ ( t ) = aq sin ( ω t ) & ( 4 )\end{matrix}$$

The following Formula (5) represents the phase modulation of the resonant waves L3 modulation q times by the cavities 9A.

$$\begin{matrix}[ Formula 5 ] & \\ exp ( i Ω t + i aq sin ω t ) = exp ( i Ω t ) {\sum }^{\pm ∞} {J}_{n} ( aq ) exp in ω t & ( 5 )\end{matrix}$$

With the cavities 9A, the number of times the modulated output waves L2 are repeatedly reflected and input again in the modulation circuit 4 is increased, whereby the degree of modulation can be increased. With the configuration described above, the modulation circuit 4 outputs the output waves L4 based on the resonant waves L3 at the second modulation frequency (Ω+nω) obtained through addition as a result of modulating the shift frequency (ω) n times.

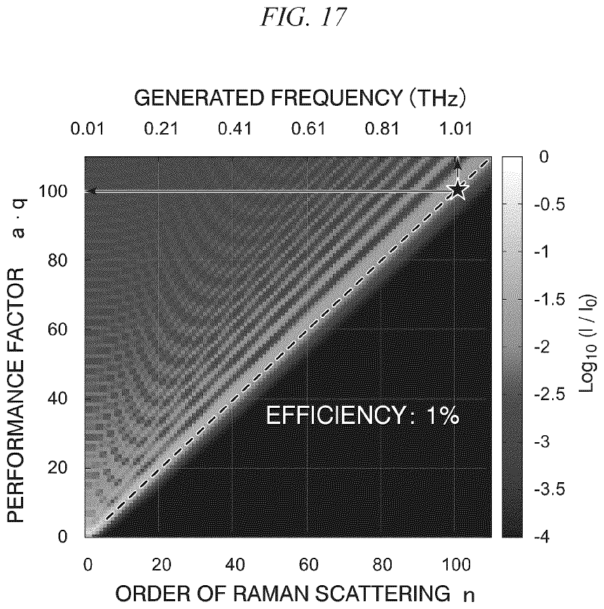

FIG. 17 illustrates a generation efficiency of the terahertz waves output as a result of the modulation according to the present embodiment. In the figure, the horizontal axis represents the order of the higher order Raman shift repeatedly generated in the modulation, and the vertical axis represents a performance factor a x q as a product of the degree of modulation a in the modulation circuit 4 and q representing the Q value that is the number of times of resonance in the cavities 9A. The figure illustrates the logarithm of the generation efficiency of the Raman scattered light generated in the modulation circuit 4, based on gradation.

An example case is described where the shift frequency in the modulation circuit 4 is 10 GHZ, the input waves L1 are input to the modulation unit 3 as microwaves at the first frequency of 10 GHZ, and the output waves L4 at 1 THz are output. The modulation unit 3 receives the input waves L1 at the first frequency of 10 GHZ, and repeats the modulation of 10 GHz at a time until 1 THz is reached based on the reflection of the modulated output waves L2, output from the modulation circuit 4, in the cavities 9A, to cause 99th order Raman shift in the modulation circuit 4. Thus, the output waves L4 at 1 THz can be output.

As illustrated in FIG. 17, the modulation unit 3 has a performance index for generating the output waves L4 at 1 THz with an efficiency of 1%, assuming that the value of α×q is 100. An existing THz-band light source generates electromagnetic waves based on an injection-seeded THz-wave parametric generator (is-TPG), with an efficiency of 0.025%. The modulation unit 3 according to the present embodiment can generate electromagnetic waves in a terahertz band with high efficiency compared with the existing light source.

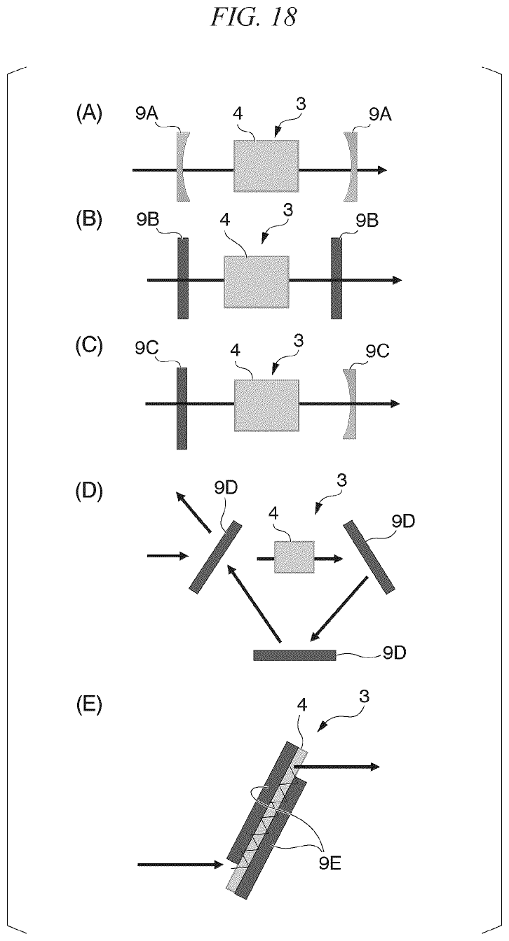

As illustrated in FIG. 18, the resonation unit 9 is not limited to the cavities 9A (see FIG. 18(A)), which are a combination of concave mirrors, and may have any other structure as long as the resonation structure in which electromagnetic waves are confined and interact with a medium for a plurality of times. For example, for the resonation unit 9, planer Fabry-Perot cavities 9B (see FIG. 18(B)) that are a combination of planer mirrors, cavities 9C (see FIG. 18(C)) that are a combination of a planer mirror and a concave mirror, ring cavities 9D (see FIG. 18(D)) with which the reflected waves are repeatedly reflected in a rotating manner, virtually imaged phased array (VIPA) multireflection cavities 9E (see FIG. 18(E)), and the like may be used. Further, the resonation unit 9 may confine the electromagnetic waves not only using reflection mirrors, but also using a wave guide tube, wave guide path, and the like.

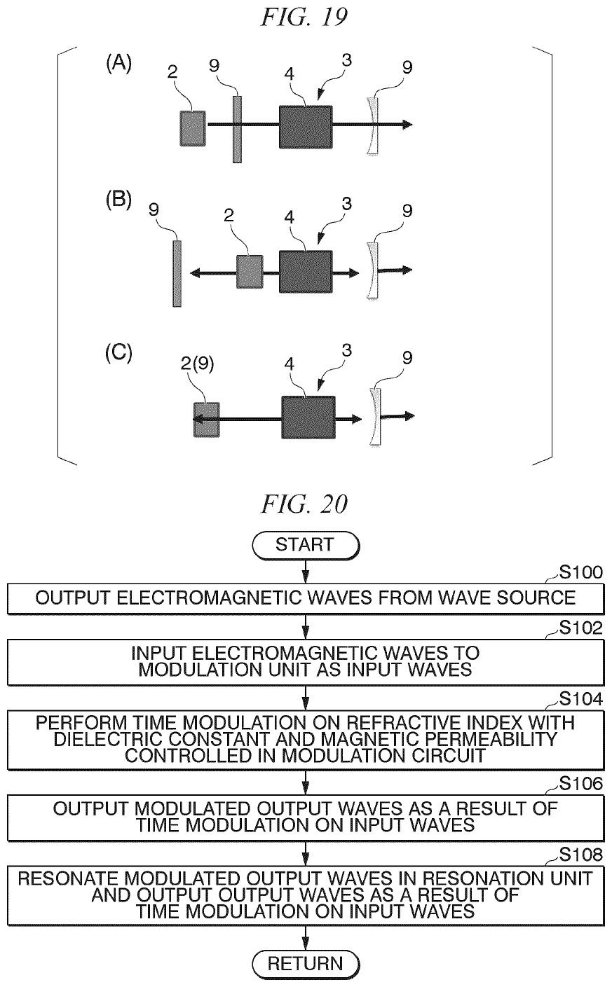

As illustrated in FIG. 19(A), the frequency conversion device 1 may have the wave source 2 provided outside the resonation unit 9. The frequency conversion device 1 may have the wave source 2 provided inside the resonation unit 9 (see FIG. 19(B)). The frequency conversion device 1 may have part of the wave source 2 forming the mirror of the resonation unit 9 (see FIG. 19(C)). In addition, the resonation unit 9 may be formed with a plurality of modulation circuits 4 connected in series (not illustrated). Furthermore, the resonation unit 9 may be formed with a predetermined number of serially connected modulation circuits 4 and cavities combined (not illustrated).

FIG. 20 illustrates steps of a modulation method for input waves modulated in the frequency conversion device 1. The electromagnetic waves at the first frequency are output from the wave source 2 (step S100). The electromagnetic waves are input to the modulation unit 3 as the input waves L1 (step S102). In the modulation circuit 4, of the modulation unit 3, formed by a metamaterial, at least one of the dielectric constant and dielectric constant is controlled, for performing time modulation on the refractive index of the modulation circuit 4 (step S104). The modulated output waves L2 are generated as a result of the time modulation of the input waves L1 in the modulation circuit 4 (step S106). Here, the first modulation circuit 5 controls the first voltage input, performs time modulation on the electric field generated in the modulation circuit, and outputs the first modulated output waves LIA as a result of the time modulation on the phase of the input waves. The second modulation circuit 6 controls the control current corresponding to the second voltage input, performs time modulation on the magnetic field generated in the modulation circuit, and outputs the second modulated output waves L1B as a result of the time modulation on the phase based on Raman scattered waves of the input waves.

The modulated output waves L2 based on the first modulated output waves LIA and the second modulated output waves LIB are resonated at least once in the resonation unit 9, whereby the resonant waves L3 are generated (step S108). Based on the resonant waves L3, the output waves L4 as a result of modulation to the second frequency higher than the first frequency are output (step S108).

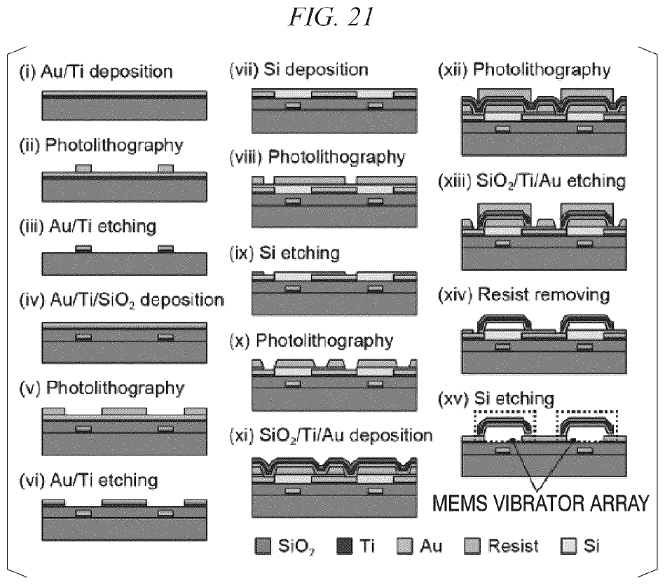

FIG. 21 illustrates one example of a method of manufacturing the first modulation circuit 5. (i) A titanium layer is formed over the entire surface on the substrate P made of silicon, by printing based on sputtering. A gold layer is formed as an upper layer of the titanium layer by printing. Thus, a metal layer is formed. (ii) A position of the third electrode 5B4 is masked by a photoresist based on the photolithography. (iii) The metal layer is removed based on etching processing, whereby the third electrode 5B4 is formed at the masked position. Of the metal layer, for example, the gold layer is removed by wet etching using a chemical solution, and the titanium layer is removed by dry etching such as ion beam milling. The photoresist is removed using a stripping solution. (iv) A layer of a thermal oxide film (SiO₂) is formed as an upper layer of the third electrode 5B4. On the surface of the layer of the thermal oxide film thus formed, a metal layer is formed by printing.

(v) Positions of the first electrode unit 5B1 and the second electrode unit 5B2 are masked by a photoresist based on photolithography. (vi) The metal layer is melted based on etching processing, whereby the first electrode unit 5B1 and the second electrode unit 5B2 are formed. The photoresist is removed using a stripping solution. (vii) A silicon layer is formed as an upper layer of the first electrode unit 5B1 and the second electrode unit 5B2. (viii) A position of the switching unit 5B3 other than one end side is masked by a photoresist based on photolithography. (ix) The silicon layer at the one end side position of the switching unit 5B3 is removed based on etching processing. The photoresist is removed using a stripping solution. (x) A portion of the switching unit 5B3 other than the one end side and the other end side is masked by a photoresist based on photolithography. (xi) A metal layer is three-dimensionally formed as an upper layer of the photoresist, and a layer of a thermal oxide film is formed as an upper layer of the metal layer.

(xii) An upper layer of the switching unit 5B3 is masked by a photoresist based on photolithography. (xiii) The layer of the thermal oxide film and the metal layer in a portion other than the switching unit 5B3 are removed based on etching processing. (xiv) The photoresist is removed using a stripping solution, whereby a void is formed inside the switching unit 5B3. (xv) The silicon layer is removed based on etching, whereby the switching unit 5B3 of a cantilever shape is formed. Based on the steps described above, the first modulation circuit 5 based on a metamaterial where the MEMS is formed can be formed.

Results are described below from a test indicating that the refractive index (magnetic permeability) generated in the modulation circuit 4 of the frequency conversion device 1 can be controlled based on the control current input externally. In the test, the spin hole effect generated in a magnetic body (for example, FeNi) having a platinum thin film formed was observed, based on the control current input to the magnetic body.

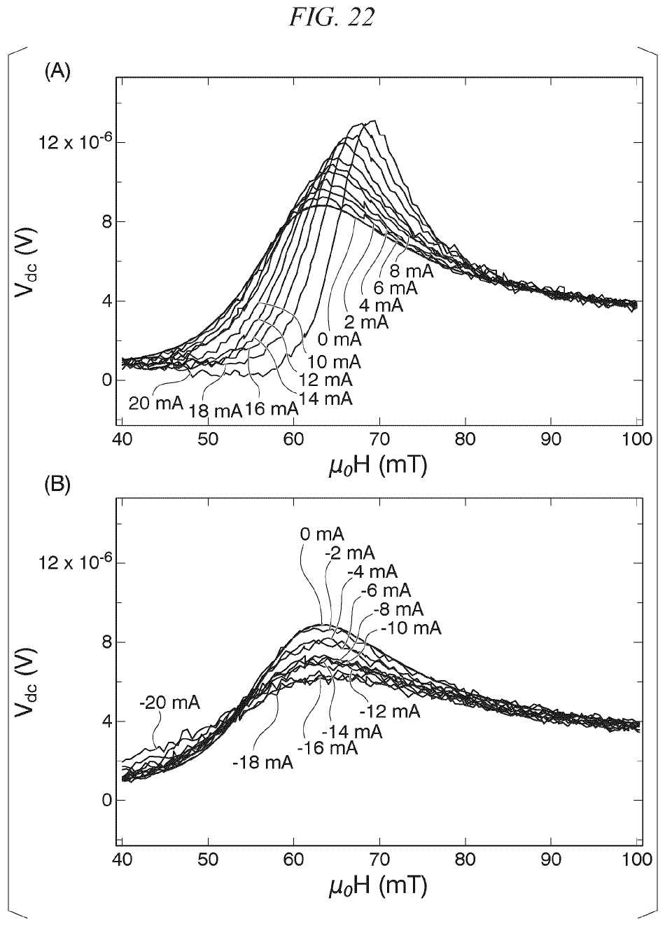

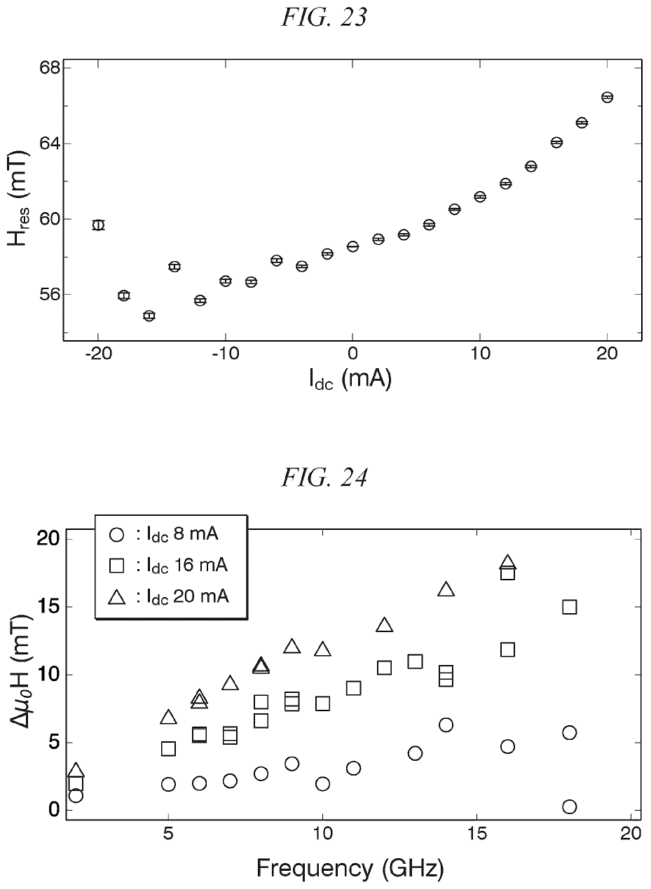

FIG. 22 illustrates results of measuring the ferromagnetic resonance spectrum observed in the magnetic body with the magnitude of the input control current changed. FIG. 23 illustrates a relationship between the resonant magnetic field obtained from the ferromagnetic resonance spectrum illustrated in FIG. 22 and the input control current. As described above, the ferromagnetic resonant magnetic field (Hᵣₑₛ) shifts based on the magnitude of the control current input to the magnetic body. Thus, the peak magnetic field of the magnetic permeability spectrum shifts based on the magnitude of the control current.

Thus, with the frequency conversion device 1, the modulation circuit 4 can control the magnetic permeability based on the magnitude of the control current input to the second modulation circuit 6. Thus, the magnetic permeability of the modulation circuit 4 can be modulated by changing the timing of turning ON/OFF the control current input to the second modulation circuit 6, that is, by adjusting the frequency of the control current.

FIG. 24 illustrates results of measuring a change in a shift amount (Δμ₀H) of the resonant magnetic field with respect to each input frequency of microwaves input to the magnetic body. Here, the shift amount of the resonant magnetic field is a value of difference in the resonant magnetic field between a case where the control current is input and a case where the control current is absent. As can be seen in the figure, the shift amount of the resonant magnetic field increases as the frequency of the microwaves input to the magnetic body becomes large. This means that the control for largely shifting the resonant magnetic field of the magnetic body enables control for largely changing the magnetic permeability of the magnetic body. A large range of change in the magnetic permeability of the magnetic body means that the frequency is efficiently converted.

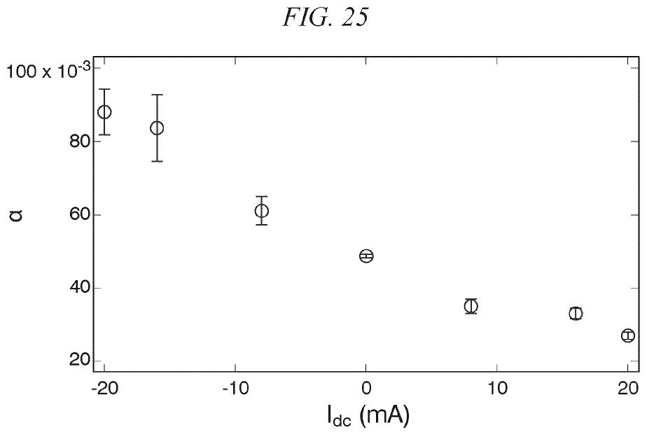

FIG. 25 illustrates a change in a value of the damping constant (a) indicating the magnitude of the magnetic friction with respect to the magnitude of the control current input to the magnetic body. As can be seen in the figure, the damping constant increases/decreases as a result of inputting the control current to the magnetic body. The control for reducing the damping constant means an effect of reducing a signal line width of the magnetic permeability spectrum of the magnetic body. Thus, with the frequency conversion device 1, the value of the magnetic permeability can be controlled by changing the shape of the magnetic permeability spectrum, based on the magnitude of the control current input to the second modulation circuit 6 in the modulation circuit 4.

In the control device 10 described above, the control unit 11 is implemented by a hardware processor such as a central processing unit (CPU) executing a program (software), for example. Some or all of the components may be implemented by hardware (including a circuit part, circuitry) such as a large scale integration (LSI), application specific integrated circuit (ASIC), field-programmable gate array (FPGA), or graphics processing unit (GPU), or may be implemented by cooperation between software and hardware. The program may be stored in advance in a storage device such as a hard disk drive (HDD) or a flash memory of the storage unit 13, or may be stored in a removable storage medium such as a DVD or a CD-ROM and may be installed with the storage medium placed in a drive device. The program is not necessarily required, and a predetermined operation may be executed with a sequential circuit formed in the control unit 11.

As described above, the frequency conversion device 1 is configured to have a small size, operates under normal temperature, and can modulate the frequency of the output waves as desired. The frequency conversion device 1 can perform time modulation on the refractive index based on control for performing time modulation on the dielectric constant and the magnetic permeability based on the modulation circuit 4 formed by a metamaterial, and can generate output waves as a result of the time modulation of the input waves. The frequency conversion device 1 can generate output waves at a frequency in any terahertz band, by performing time modulation on the magnetic permeability based on the second modulation circuit 6 to perform time modulation of the input waves in a GHz band, and performing time modulation on the dielectric constant based on the first modulation circuit 5 to perform time modulation of the input waves to a MHz band.

The frequency conversion device 1 can generate the modulated output waves modulated to be in a GHz band, using scattered waves generated through Raman scattering in the modulation circuit 4 formed by a metamaterial. Furthermore, the frequency conversion device 1 can repeatedly perform modulation at the modulation frequency through resonation, in the resonation unit 9, of the modulated output waves L2 output from the modulation circuit 4, and thus can output the output waves L4 modulated to be in a terahertz band.

While some embodiments of the invention are described above, the embodiments are merely provided as an example, and are not intended to limit the scope of the invention. These embodiments can be implemented in various other modes, and various omissions, replacements, and changes can be made without departing from the gist of the invention. These embodiments and their modifications are included in the scope and the gist of the invention, and are also included in the scope of the invention described in the claims and its equivalents. For example, while the frequency conversion device 1 uses the modulated output waves L2 obtained by shifting the input waves L1 toward the high frequency side in the modulation unit 3 in an example described in the above embodiment, the modulated output waves L2 shifted toward the low frequency side may be used.

### REFERENCE SIGNS LIST

1: frequency conversion device
2: wave source
3: modulation unit
4: modulation circuit
5: first modulation circuit
5A: first metamaterial
5B: first pattern
5B1: first electrode unit
5B2: second electrode unit
5B3: switching unit
6: second modulation circuit
6A: second metamaterial
6B: second pattern
6A1: first layer
6A2: second layer
9: resonation unit
9A: cavity

1. A frequency conversion device comprising a modulator configured to receive electromagnetic waves at a first frequency output from a wave source as input waves, and output output waves as a result of modulation to a second frequency higher than the first frequency, wherein
the modular includes a modulation circuit formed by a metamaterial configured to receive the input waves and generate modulated waves, and
the modulation circuit includes:
a first modulation circuit configured to generate first modulated output waves as a result of first modulation on a phase of the input waves through time modulation on the dielectric constant based on control of an electric field generated in the modulation circuit; and
a second modulation circuit configured to generate second modulated output waves as a result of second modulation on the phase of the input waves through time modulation on the magnetic permeability based on control of a magnetic field generated in the modulation circuit,
the modulation circuit generates modulated output waves as a result of time modulation of the input waves in based on the first modulated output waves, the second modulated output waves and a refractive index on which time modulation is performed based on control on at least one of dielectric constant and magnetic permeability.

2. (canceled)

3. The frequency conversion device according to claim 1, wherein the first modulation circuit is formed by a first metamaterial with a predetermined first pattern repeatedly formed, the first metamaterial performing time modulation on the dielectric constant based on the electric field generated in the first pattern based on control.

4. The frequency conversion device according to claim 3, wherein
the first pattern includes:
a pair of a first electrode and a second electrode with a potential difference; and
a switch configured to switch an electrical connection between the first electrode and the second electrode to an ON state or an OFF state based on control, and
the time modulation on the dielectric constant is performed based on a variation of the electric field generated in accordance with a connection state by the switch.

5. The frequency conversion device according to claim 4, wherein in the switch, a cantilever is formed that elastically deforms and vibrates based on input waves at a resonance frequency, to electrically connect the first electrode and the second electrode intermittently.

6. The frequency conversion device according to claim 1, wherein the second modulation circuit is formed by a second metamaterial with a predetermined second pattern formed that generates a magnetic field based on a control signal to perform the time modulation on the magnetic permeability.

7. The frequency conversion device according to claim 6, wherein the second pattern changes the magnetic permeability based on at least one of a current, voltage, and magnetic field input, and performs the time modulation on the magnetic permeability based on control to perform time modulation on the current or the voltage.

8. The frequency conversion device according to claim 1, wherein the modulator includes a resonator configured to output the output waves based on resonant waves as a result of resonating the modulated output waves, output from the modulation circuit, at least once.

9. The frequency conversion device according to claim 8, wherein the resonator includes a cavity configured to reflect the modulated output waves at least once and output the output waves.

10. A frequency conversion method comprising:
outputting electromagnetic waves at a first frequency from a wave source;
inputting the electromagnetic waves to a modulation unit as input waves;
by a modulation circuit formed by a metamaterial included in the modulator, controlling at least one of dielectric constant and magnetic permeability to perform time modulation on a refractive index of the modulation circuit;
by the modulation circuit, generating first modulated output waves as a result of first modulation on a phase of the input waves through time modulation on the dielectric constant based on control of an electric field generated in the modulation circuit,
generating second modulated output waves as a result of second modulation on the phase of the input waves through time modulation on the magnetic permeability based on control of a magnetic field generated in the modulation circuit, and
outputting output waves as a result of modulation to a second frequency higher than the first frequency based on the first modulated output waves and the second modulated output waves.
